(19) United States
(12) Patent Application Publication
(10) Pub. No.: US 2026/0268550 A1
(43) Pub. Date: Sep. 10, 2026

(54) IMPROVED TEXT RENDERING IN GENERATED IMAGES

(71) Applicant: ADOBE INC., SAN JOSE, CA (US)

(72) Inventors: Zhaowen Wang, San Jose, CA (US); Nipun Jindal, Delhi (IN)

(21) Appl. No.: 19/071,954

(22) Filed: Mar. 6, 2025

(51) Int. Cl. G06T 11/60; G06T 3/40; G06V 30/19

(52) U.S. Cl. CPC G06T 11/60; G06T 3/40; G06V 30/191

(57) ABSTRACT

A method, apparatus, non-transitory computer readable medium, and system for improving text legibility in generated images include processing an input prompt that indicates a visual text. An image generation model performs a first cross-attention operation based on the input prompt and a second cross-attention operation based on the visual text. The image generation model then generates a synthetic image depicting the visual text by combining results from both cross-attention operations.

### BACKGROUND

The following relates generally to data processing, and more specifically to image generation. Data processing involves manipulating different types of data to achieve desired results, such as extracting additional information and insights. Various forms of data processing include image processing, audio processing, sequence prediction, and text processing. Image processing, for example, may involve enhancing the visual quality of an image or extracting specific information from it.

Image generation is a type of image processing that involves the creation of synthetic images. Recently, generative artificial intelligence (AI) models have been developed to generate realistic images. For example, denoising diffusion models generate samples by transforming an initial random noise distribution into a data distribution over a series of time steps. A denoising diffusion model can be conditioned on a text description, such that the diffusion process generates images that match the text. In some cases, texts that are reproduced in the generated images can be illegible.

### SUMMARY

Embodiments of the present inventive concepts described herein include systems and methods for generating synthetic images with legible texts. Embodiments include an image processing apparatus with two text encoders: a word encoder and a glyph encoder. A user provides an input prompt that indicates a text to be displayed in the generated image. The word encoder generates prompt features that contribute semantic meaning of the input prompt to the image generation process. The glyph encoder generates glyph features that contribute a per-character meaning of the input prompt that improves the reproduction of the text in the generated image. Embodiments may apply the prompt features and the glyph features to first and second cross-attention modules, respectively, wherein each cross-attention module is trained to attend to different aspects of the text: the first cross-attention module attends to semantic relationships between the text and image content, while the second cross-attention module attends to character-level structural patterns for accurate text reproduction. Embodiments may further augment the prompt features with OCR features from an OCR encoder that encode visual aspects of the text to be rendered.

A method, apparatus, non-transitory computer readable medium, and system for image generation are described. One or more aspects of the method, apparatus, non-transitory computer readable medium, and system include obtaining an input prompt indicating a visual text; performing, using an image generation model, a first cross-attention operation based on the input prompt; performing, using the image generation model, a second cross-attention operation based on the visual text; and generating, using the image generation model, a synthetic image depicting the visual text based on the first cross-attention operation and the second cross-attention operation.

A method, apparatus, non-transitory computer readable medium, and system for image generation are described. One or more aspects of the method, apparatus, non-transitory computer readable medium, and system include obtaining an input prompt indicating a visual text; encoding, using a word encoder of an image generation model, the input prompt to obtain prompt features; encoding, using a glyph encoder of the image generation model, the input prompt to obtain text features; and generating, using the image generation model, a synthetic image depicting the visual text based on the prompt features and the text features.

An apparatus, system, and method for image generation are described. One or more aspects of the apparatus, system, and method include a memory component; a processing device coupled to the memory component, the processing device configured to perform operations comprising: obtaining an input prompt indicating a visual text; performing, using an image generation model, a first cross-attention operation based on the input prompt; performing, using the image generation model, a second cross-attention operation based on the visual text; and generating, using the image generation model, a synthetic image depicting the visual text based on the first cross-attention operation and the second cross-attention operation.

### BRIEF DESCRIPTION OF THE DRAWINGS

FIG. 1 shows an example of an image processing system according to aspects of the present disclosure.

FIG. 2 shows an example of an image processing apparatus according to aspects of the present disclosure.

FIG. 3 shows an example of a word encoder and a glyph encoder according to aspects of the present disclosure.

FIG. 4 shows an example of an OCR encoder according to aspects of the present disclosure.

FIG. 5 shows an example of a guided latent diffusion model according to aspects of the present disclosure.

FIG. 6 shows an example of a U-Net according to aspects of the present disclosure.

FIG. 7 shows an example of a pipeline for generating images with legible visual according to aspects of the present disclosure.

FIG. 8 shows an example of a pipeline for upscaling generated images according to aspects of the present disclosure.

FIG. 9 shows an example of a method a diffusion process according to aspects of the present disclosure.

FIG. 10 shows an example of a method for generating a synthetic image according to aspects of the present disclosure.

FIG. 11 shows an example of a pipeline for computing an OCR loss according to aspects of the present disclosure.

FIG. 12 shows an example of a step-by-step algorithm for training a machine learning (ML) model according to aspects of the present disclosure.

FIG. 13 shows an example of a method for training a diffusion model according to aspects of the present disclosure.

FIG. 14 shows an example of a computing device according to aspects of the present disclosure.

FIG. 15 shows an example of a diffusion transformer (DiT) architecture according to aspects of the present disclosure.

FIG. 16 shows an example of a visual text according to aspects of the present disclosure.

### DETAILED DESCRIPTION

Generative AI has transformed creative workflows. Users are able to generate high-quality images by conveying their ideas in a text prompt to generative models. For example, in an ideation phase, a creator begins by conceptualizing a distinct scene or object they wish to visualize. This might be a fantastical creature, a surreal landscape, or a complex object that would be challenging to draw or model by hand. The creator then condenses this idea into a concise, descriptive text prompt, carefully choosing language to capture the salient features of the envisioned scene or object. The prompt might describe colors, shapes, spatial relationships, mood, or any other aspects of the concept that the creator deems important.

In some cases, a creator may wish to generate an image that includes text within the image itself, referred to herein as “visual text”. However, conventional models often fail to create images with legible scene text. The generated images may include letters that are misshaped or garbled, or words that are misspelled.

One typical approach to improving the legibility of text in generated images focuses on character-level processing during image generation. These approaches modify the conventional text encoding pipeline by incorporating character-aware mechanisms that process text at the individual letter level rather than at the word level. While this helps with character formation, processing text only at the character level can result in generated images that fail to maintain semantic coherence between the text and the surrounding image content.

Other conventional approaches attempt to address text rendering by simultaneously processing both word-level and character-level information. These methods typically combine multiple types of text representations into a unified input encoding. However, such combined representations often lead to conflicts between semantic understanding and accurate character reproduction, as the model cannot effectively separate these visual aspects during the generation process.

When generating an image with text, image generation models must simultaneously consider both the meaning of the text in relation to the scene (e.g., ensuring that a store sign matches the type of store being depicted) and the proper visual representation of each individual character. Conventional approaches that attempt to balance these competing requirements often compromise one aspect in favor of the other.

In some cases, image generation systems struggle to reproduce legible text because they must process two distinct aspects of text rendering: the semantic relationship between text and image content, and the accurate reproduction of character shapes. Conventional approaches, which rely solely on character-level processing or form a unified input with different word/char-level encodings, can sacrifice text legibility to maintain semantic consistency or compromise semantic coherence to achieve better character formation.

Embodiments of the present inventive concepts improve both the accuracy of rendered text and the semantic coherence of generated images. Embodiments include an image processing apparatus that processes input text through multiple text encoders to extract different types of features. A word encoder and a glyph encoder process semantic and character-level information, respectively, from the input text. Embodiments include cross-attention modules that separately process these different features during image generation. Accordingly, the generated images depict the global semantic contexts from the prompt as well as the fine details of the visual text from the prompt (for example, the prompt may be “a sign displaying {visual text}”). Some embodiments further incorporate an OCR encoder to extract visual text features. In some embodiments, the image generation model is trained using an OCR loss function that encourages the model to maintain text features in relevant image regions.

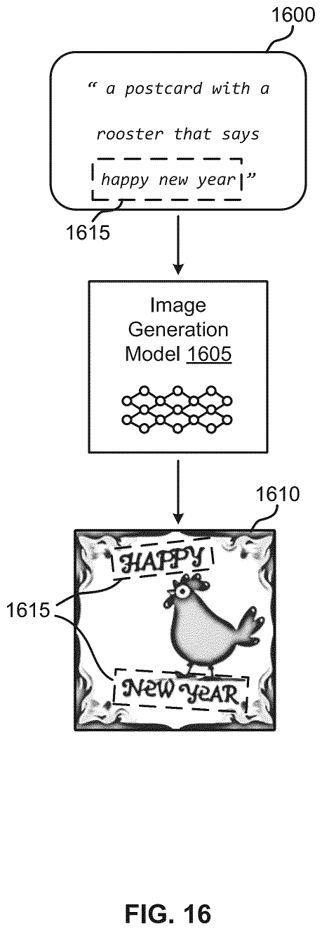

As used herein, a “visual text” refers to a text intended to be rendered in a generated image. For example, the visual text in the input prompt “a post card that says happy birthday” may be “happy birthday”. An example of visual text is described with reference to FIG. 16.

As used herein, “prompt features” refer to the encoding of an input prompt by a word-level encoder, such as the T5 encoder. A word level encoder creates a sequence of vector representations for each word or sub-word in an input prompt. For example, the word level encoder may generate a sequence of token embeddings, where each token corresponds to a word or sub-word from the input prompt and is represented as a vector in a high-dimensional vector space. In some embodiments, the sequence of token embeddings may be further processed, such as through pooling or aggregation, to form a single embedding representation of the entire prompt.

As used herein, “text features” refer to the encoding of the input prompt by a character level encoder, also referred to herein as a “glyph encoder”. The character level encoder processes the input prompt to generate a sequence of vector representations, sometimes referred to as “character embeddings,” for each character in the input. These embeddings capture fine-grained features specific to individual characters and their context within the input prompt. In at least one embodiment, another model, such as a language model, may first extract the visual text from the input prompt. The system then encodes only the extracted visual text using the character level encoder to generate the text features.

As used herein, an optical character recognition (OCR) encoder generally refers to a convolutional neural network (CNN)-based network that processes pixel or latent visual information to obtain visual features. It does not necessarily refer to the direct mapping of visual information to glyphs, unless explicitly specified. The visual features may be used downstream to, for example, compute losses or to guide image generation. In some embodiments, the OCR encoder generates OCR features in a first space, and then linearly projects the features to a second space, such as the space of the features generated by the word level encoder.

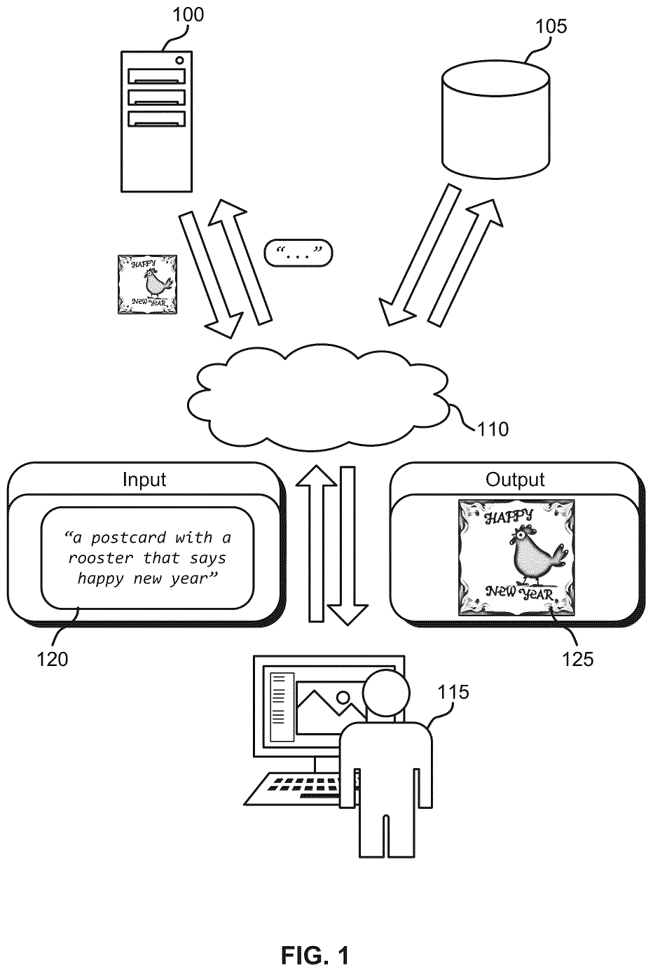

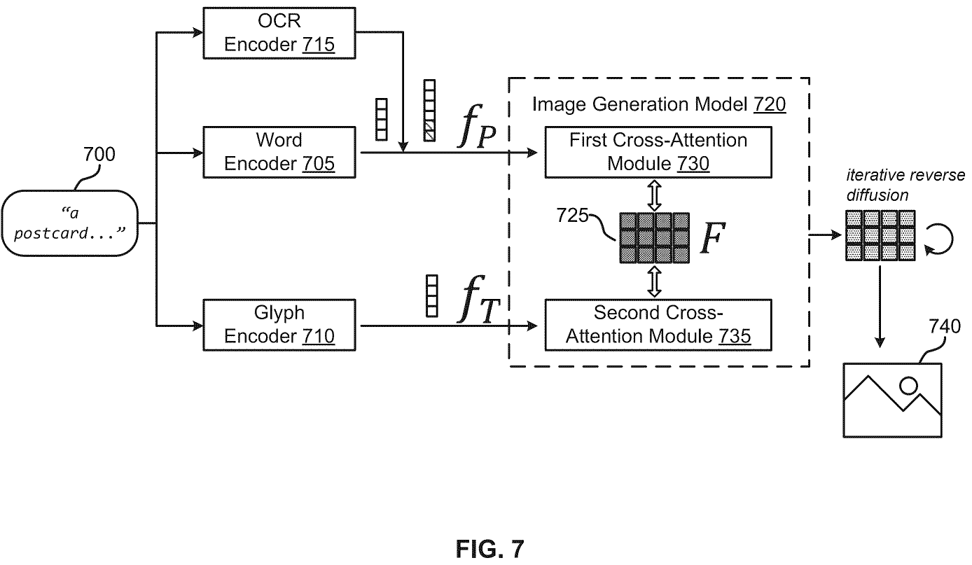

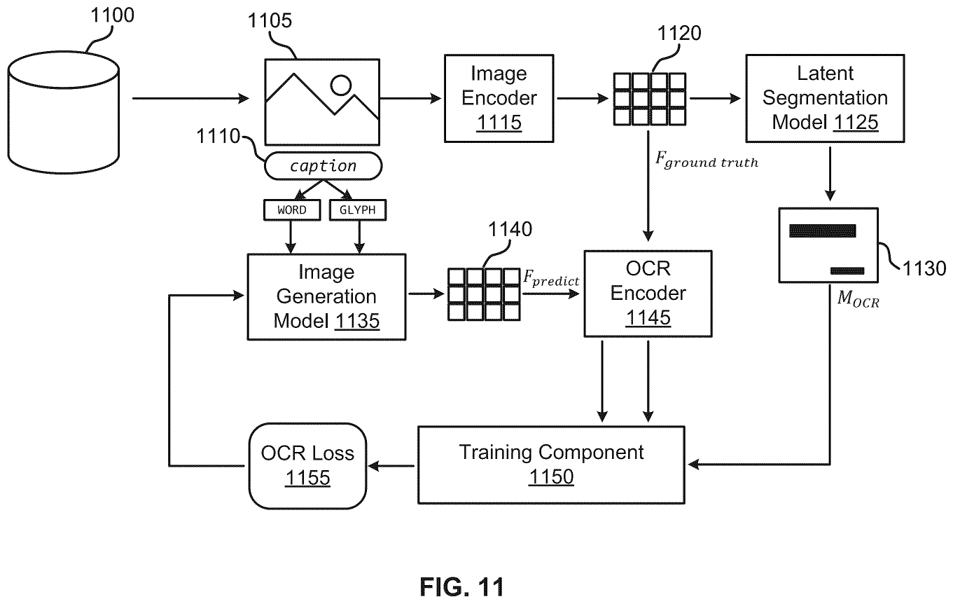

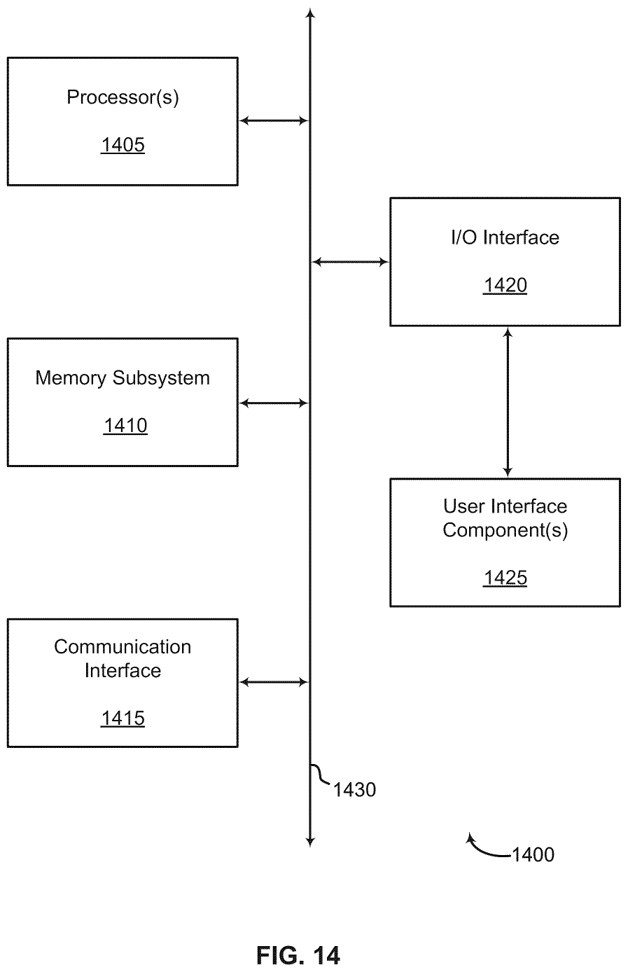

An image generation system is described with reference to FIGS. 1-6. Methods and pipelines for generating synthetic images are described with reference to FIGS. 7-10. Training methods are described with reference to FIGS. 11-13. A computing device configured to implement an image generation apparatus is described with reference to FIG. 14.

### Image Generation System

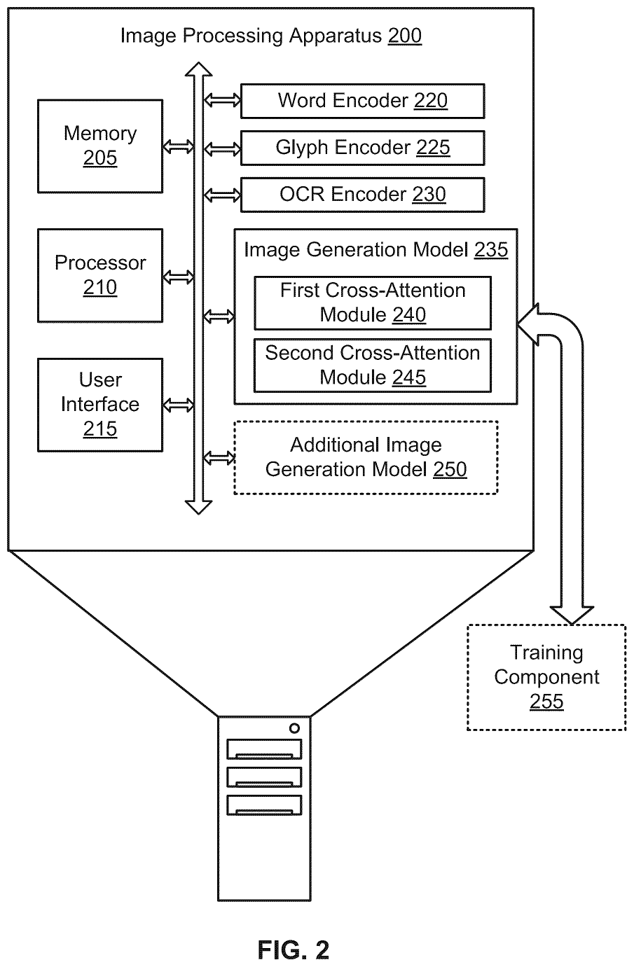

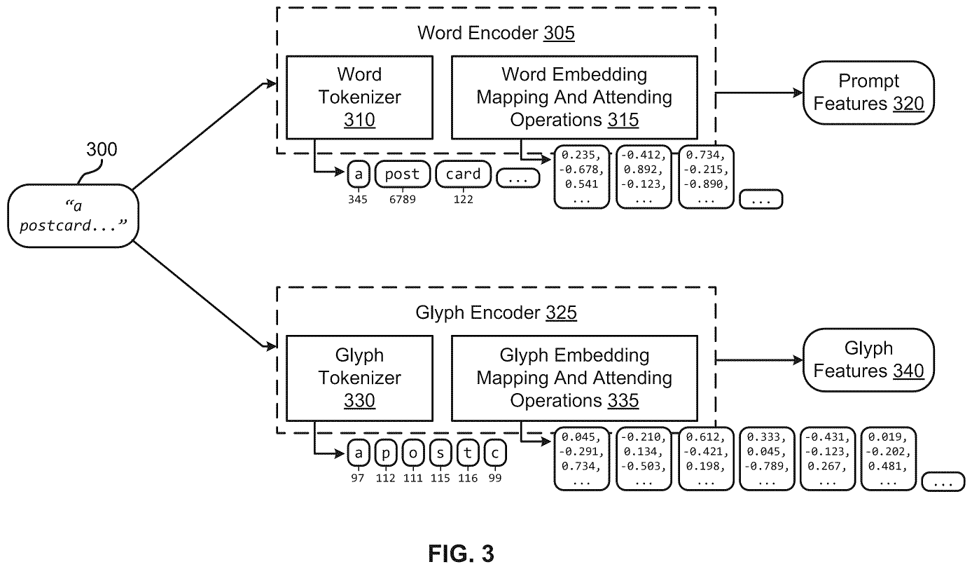

FIG. 1 shows an example of an image processing system according to aspects of the present disclosure. The example shown includes image processing apparatus 100, database 105, network 110, user 115, input prompt 120, and output synthetic image 125. Image processing apparatus 100 is an example of, or includes aspects of, the corresponding element described with reference to FIG. 2. Database 105 is an example of, or includes aspects of, the corresponding element described with reference to FIG. 11. Input prompt 120 is an example of, or includes aspects of, the corresponding element described with reference to FIGS. 3 and 7.

In this example, user 115 provides input prompt 120 to the system. The input prompt 120 may include a “visual text”, which are words that the user wishes to have depicted in a generated image. In this case, the visual text includes “happy new year”. Then, image processing apparatus 100 generates output synthetic image 125 using an image generation model. The output synthetic image 125 depicts the visual text legibly. The system may then provide output synthetic image 125 back to user 115 for further edits or re-generation.

Embodiments of image processing apparatus 100 include components that are implemented on a server. A server provides one or more functions to users linked by way of one or more of available networks, such as network 110. In some cases, the server includes a single microprocessor board, which includes a microprocessor responsible for controlling all aspects of the server. In some cases, a server uses microprocessors and protocols to exchange data with other devices/users on one or more of the networks via hypertext transfer protocol (HTTP), and simple mail transfer protocol (SMTP), although other protocols such as file transfer protocol (FTP), and simple network management protocol (SNMP) may also be used. In some cases, a server is configured to send and receive hypertext markup language (HTML) formatted files (e.g., for displaying web pages). In various embodiments, a server comprises a general-purpose computing device, a personal computer, a laptop computer, a mainframe computer, a super computer, or any other suitable processing apparatus.

Database 105 stores information used by the image processing system, such as model parameters, embeddings, training data, instructions and code libraries, stock images, previously generated images, and the like. A database is an organized collection of data. For example, database 105 stores data in a specified format known as a schema. A database may be structured as a single database, a distributed database, multiple distributed databases, or an emergency backup database. In some cases, a database controller may manage data storage and processing in database 105. In some cases, a user interacts with the database controller. In other cases, the database controller may operate automatically without user interaction.

Network 110 facilitates the transfer of information between image processing apparatus 100, database 105, and user 115. Network 110 may be referred to as a “cloud.” A cloud is a computer network configured to provide on-demand availability of computer system resources, such as data storage and computing power. In some examples, the cloud provides resources without active management by a user. The term cloud is sometimes used to describe data centers available to many users over the Internet. Some large cloud networks have functions distributed over multiple locations from central servers. A server is designated an edge server if it has a direct or close connection to a user. In some cases, a cloud is limited to a single organization. In other examples, the cloud is available to many organizations. In one example, a cloud includes a multi-layer communications network comprising multiple edge routers and core routers. In another example, a cloud is based on a local collection of switches in a single physical location.

FIG. 2 shows an example of an image processing apparatus 200 according to aspects of the present disclosure. The example shown includes image processing apparatus 200, memory 205, processor 210, user interface 215, word encoder 220, glyph encoder 225, OCR encoder 230, image generation model 235, additional image generation model 250, and training component 255. Image processing apparatus 200 is an example of, or includes aspects of, the corresponding element described with reference to FIG. 1.

Memory 205 stores information used by image processing apparatus 200. In some embodiments, word encoder 220, glyph encoder 225, OCR encoder 230, image generation model 235, and additional image generation model 250 are implemented as sets of instructions and model parameters that are stored within memory 205.

Memory 205 includes one or more memory devices. Examples of a memory device include random access memory (RAM), read-only memory (ROM), or a hard disk. Examples of memory devices include solid state memory and a hard disk drive. In some examples, memory 205 is used to store computer-readable, computer-executable software including instructions that, when executed, cause processor 210 to perform various functions described herein. In some cases, memory 205 contains, among other things, a basic input/output system (BIOS) which controls basic hardware or software operation such as the interaction with peripheral components or devices. In some cases, a memory controller operates memory cells. For example, the memory controller can include a row decoder, column decoder, or both. In some cases, memory cells within memory 205 store information in the form of a logical state.

A processor 210 is an intelligent hardware device, (e.g., a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or any combination thereof). In some cases, processor 210 is configured to operate memory 205 array using a memory controller. In other cases, a memory controller is integrated into processor 210. In some cases, processor 210 is configured to execute computer-readable instructions stored in memory 205 to perform various functions. In some embodiments, processor 210 includes special purpose components for modem processing, baseband processing, digital signal processing, or transmission processing.

User interface 215 enables a user to interact with image processing apparatus 200. In some embodiments, user interface 215 includes an audio device, such as an external speaker system, an external display device such as a display screen, or an input device (e.g., remote control device interfaced with the user interface 215 directly or through an IO controller module). In some cases, a user interface 215 may include a graphical user interface (GUI).

Word encoder 220 processes text at the word or sub-word level. Word encoder 220 is configured to encode an input prompt to generate a sequence of token embeddings that represent words or sub-word units from the input prompt. In some embodiments, word encoder 220 includes a T5 encoder with byte-pair encoding (BPE) tokenization. Word encoder 220 encodes the input prompt to obtain prompt features, which are used to condition the image generation process performed by image generation model 235 and additional image generation model 250. Word encoder 220 is an example of, or includes aspects of, the corresponding element described with reference to FIGS. 3 and 7.

Glyph encoder 225 processes text at the character level. Glyph encoder 225 is configured to encode the input prompt to generate a sequence of embeddings, where each embedding represents a single character from the input prompt. Glyph encoder 225 encodes the input prompt to obtain text features. Glyph encoder 225 is an example of, or includes aspects of, the corresponding element described with reference to FIGS. 3 and 7.

Embodiments of word encoder 220 and glyph encoder 225 include artificial neural network (ANN) structures such as the Transformer. A transformer or transformer network is a type of neural network model used for natural language processing tasks. A transformer network transforms one sequence into another sequence using an encoder and a decoder. Encoder and decoder include modules that can be stacked on top of each other multiple times. The modules comprise multi-head attention and feed forward layers. The inputs and outputs (target sentences) are first embedded into an n-dimensional space. Positional encoding of the different words (i.e., give every word/part in a sequence a relative position since the sequence depends on the order of its elements) are added to the embedded representation (n-dimensional vector) of each word. In some examples, a transformer network includes attention mechanism, where the attention looks at an input sequence and decides at each step which other parts of the sequence are important. The attention mechanism uses queries (Q), keys (K), and values (V). Q represents the query, or the part of the sequence the model is currently focusing on, K represents all the parts of the sequence the model is comparing the query against, and V represents the associated values. By comparing Q with K, the model calculates how much attention each part of the sequence deserves and combines the parts of V accordingly. The result is a constant-dimensional vector, which is a weighted combination of the values in V, reflecting the attention given to different parts of the sequence. In a ViT, rather than processing token embeddings corresponding to portions of words, the model processes embeddings corresponding to patches from an input image. Some embodiments of the image generation models described herein may be based on a ViT, or a diffusion-based transformer (DiT).

OCR encoder 230 generates visual features from the input prompt. OCR encoder 230 includes components for processing text as visual elements. In some embodiments, OCR encoder 230 includes a rendering component that converts characters from the input prompt into pixel representations, and a convolutional neural network (CNN) based model that extracts features from these pixel representations. A CNN processes image data through layers of mathematical operations called convolutions, which analyze patterns and features at different spatial scales.

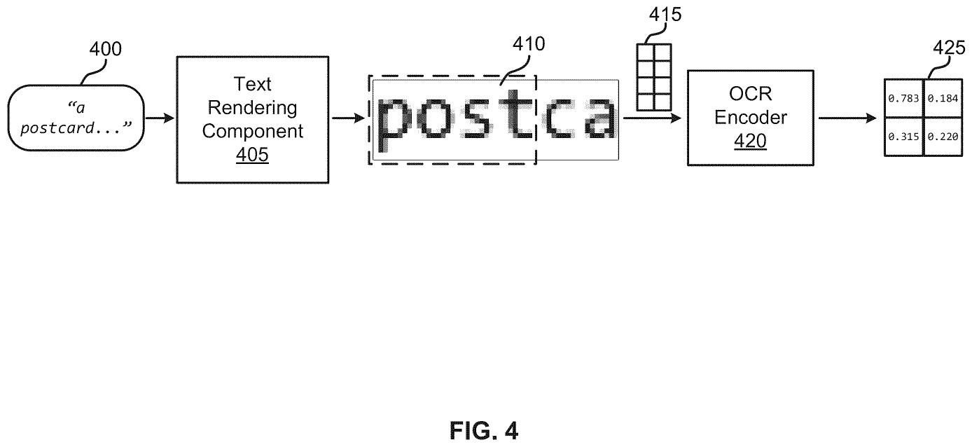

According to some aspects, OCR encoder 230 performs optical character recognition (OCR) on the visual text, where the generated prompt features are based on the OCR. According to some aspects, OCR encoder 230 is configured to encode the input prompt to obtain OCR embeddings. The prompt features may be concatenated with the OCR embeddings to obtain updated prompt features used to condition image generation. OCR encoder 230 is an example of, or includes aspects of, the corresponding element described with reference to FIGS. 4, 7, and 11.

Image generation model 235 is configured to generate a synthetic image based on the input prompt. According to some aspects, image generation model 235 generates the synthetic image depicting the visual text based on a first cross-attention operation performed by first cross-attention module 240 and a second cross-attention operation performed by second cross-attention module 245. In some examples, image generation model 235 combines a result of the first cross-attention operation and a result of the second cross-attention operation to obtain combined image features, where the synthetic image is generated based on the combined image features. Embodiments of image generation model 235 include any generative model capable of incorporating condition(s) using cross-attention, such as U-Net-based diffusion models and diffusion transformer (DiT) models. Image generation model 235 is an example of, or includes aspects of, the corresponding element described with reference to FIGS. 7, 8, and 11.

First cross-attention module 240 is configured to perform cross-attention operations between image features from image generation model 235 and prompt features from word encoder 220. While standard attention computes relationships between elements within a single sequence, cross-attention computes relationships between two different sequences. In cross-attention, query vectors are derived from one sequence (in this case, the image features), while key and value vectors are derived from another sequence (in this case, the prompt features from word encoder 220). This enables first cross-attention module 240 to identify regions in the image features that should incorporate semantic information from the input prompt. First cross-attention module 240 is an example of, or includes aspects of, the corresponding element described with reference to FIG. 7.

Second cross-attention module 245 is configured to perform cross-attention operations between image features from image generation model 235 and text features from glyph encoder 225. Similar to first cross-attention module 240, second cross-attention module 245 computes query vectors from the image features and key-value pairs from the encoder features. However, second cross-attention module 245 processes character-level features from glyph encoder 225, allowing the module to identify image regions where character-level information should be incorporated into the generated image. Second cross-attention module 245 is an example of, or includes aspects of, the corresponding element described with reference to FIG. 7.

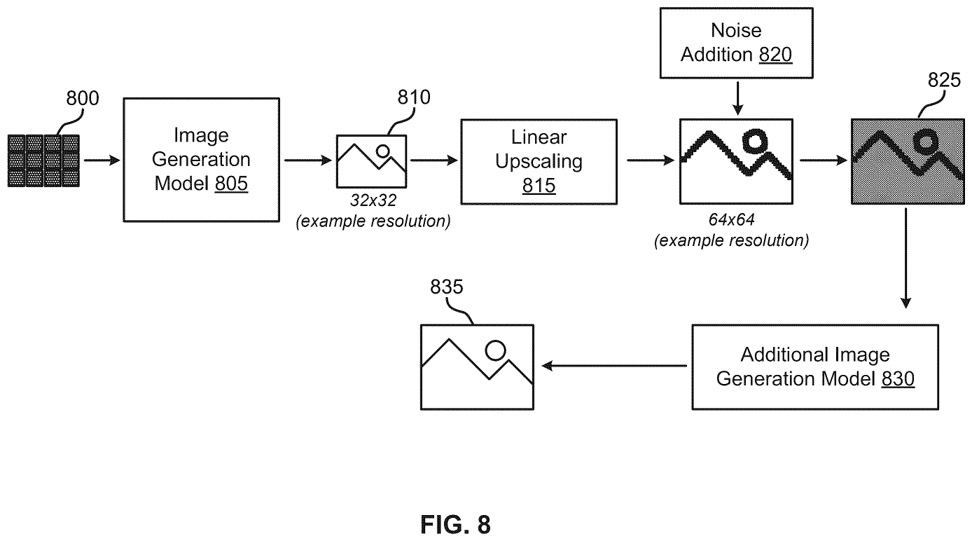

According to some aspects, additional image generation model 250 upscales the synthetic image to obtain a high resolution image. Embodiments of additional image generation model 250 include any generative model capable of incorporating condition(s) using cross-attention, such as U-Net-based diffusion models and diffusion transformer (DiT) models. According to some aspects, additional image generation model 250 adds a predetermined amount of noise to a 2×-resolution version of the synthetic image generated by image generation model 235, and then denoises this noised image to obtain the upscaled image. Additional image generation model 250 is an example of, or includes aspects of, the corresponding element described with reference to FIG. 8.

Training component 255 is configured to update parameters of image generation model 235 and additional image generation model 250 during one or more training phases. Training component 255 is an example of, or includes aspects of, the corresponding element described with reference to FIG. 11. Additional training detail is described with reference to FIGS. 11-13.

FIG. 3 shows an example of a word encoder 305 and a glyph encoder 325 according to aspects of the present disclosure. The example shown includes input prompt 300, word encoder 305, prompt features 320, glyph encoder 325, and glyph features 340. Input prompt 300 is an example of, or includes aspects of, the corresponding element described with reference to FIGS. 1 and 7. Word encoder 305 is an example of, or includes aspects of, the corresponding element described with reference to FIGS. 2 and 7. Glyph encoder 325 is an example of, or includes aspects of, the corresponding element described with reference to FIGS. 2 and 7.

Word encoder 305 is a text encoder configured to encode input prompt 300 to generate an embedding, prompt features 320. A text encoder transforms text input into numerical representations that machine learning models can process. These numerical representations, called embeddings, capture semantic relationships between words in a high-dimensional space.

In one aspect, word encoder 305 includes word tokenizer 310 and word embedding mapping and attending operations 315. Word tokenizer 310 breaks the input text into units called tokens, which may be words or parts of words. For example, word tokenizer 310 may split the input prompt “a postcard” into the tokens “a”, “post”, and “card”. In some embodiments, word encoder 305 includes a BPE-based tokenizer such as the T5-encoder, though embodiments are not limited thereto. Word tokenizer 310 maps each token to a unique numerical identifier. Word embedding mapping and attending operations 315 then convert these identifiers into vectors of numbers (embeddings) where similar words have similar vector representations. For example, the operations may include obtaining an initial vector definition for each word or subword from a dictionary, and then updating each vector based on attention operations. These operations allow the encoder to capture meaningful relationships between words while maintaining a fixed-size representation regardless of the input text length.

In one aspect, glyph encoder 325 includes glyph tokenizer 330 and glyph embedding mapping and attending operations 335. Similar to word encoder 305, glyph encoder 325 transforms input text into numerical representations. However, glyph tokenizer 330 processes text at the character level, generating separate tokens for each character in the input prompt. For example, glyph tokenizer 330 splits the input prompt “a postcard” into the sequence of characters ‘a’, ‘p’, ‘o’, ‘s’, ‘t’, ‘c’, ‘a’, ‘r’, ‘d’. Glyph embedding mapping and attending operations 335 then convert each character token into an embedding vector that captures character-level patterns and relationships.

FIG. 4 shows an example of an OCR encoder 420 according to aspects of the present disclosure. The example shown includes text prompt 400, text rendering component 405, image of text 410, latent image features 415, OCR encoder 420, and OCR features 425. OCR encoder 420 is an example of, or includes aspects of, the corresponding element described with reference to FIGS. 2, 7, and 11.

Some embodiments of the image processing apparatus augment the prompt features obtained from the word encoder with OCR features generated from a CNN-based model. These OCR features represent visual characteristics of the text and may be projected into the same embedding space as the prompt features, such as the T5 embedding space, and then concatenated with the prompt features.

In an example, text rendering component 405 first translates text prompt 400 into pixel representations of the text, producing image of text 410. This translation may use various available techniques, such as the operations performed by device operating systems to render onscreen text. Next, a CNN-based model generates latent image features 415, which provide a spatial mapping of latent visual information (such as encodings of patterns) from the text. Finally, OCR encoder 420, which may be an additional CNN-based model, further generates OCR features 425 from the latent image features 415. Accordingly, OCR encoder 420 may extract visual features that represent text patterns from a latent spatial map, such as the spatial maps processed by a guided latent diffusion model during image generation. In at least one embodiment, OCR encoder 420 is configured to operate in the pixel space directly.

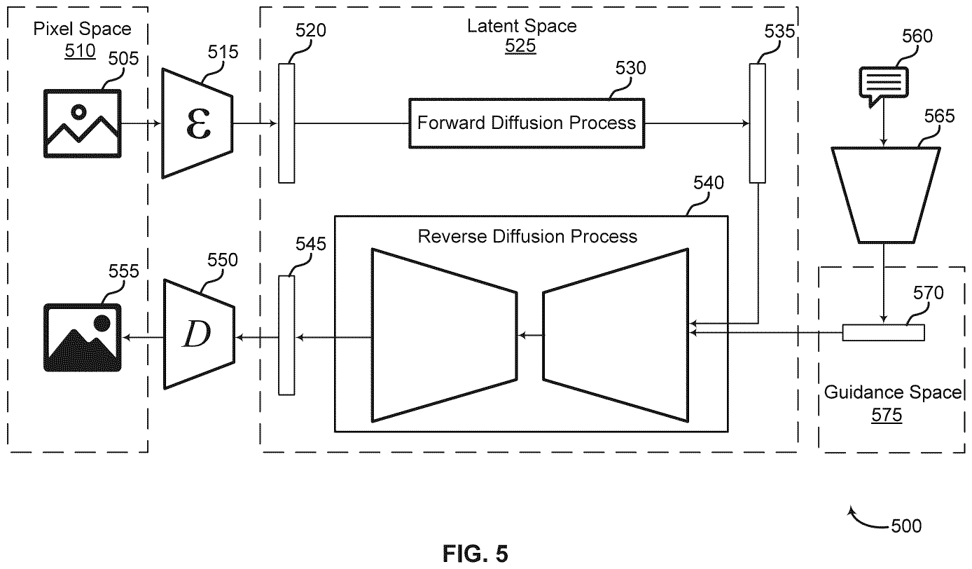

FIG. 5 shows an example of a guided latent diffusion model 500 according to aspects of the present disclosure. The guided latent diffusion model 500 depicted in FIG. 5 is an example of, or includes aspects of, the image generation model 235 described with reference to FIG. 2.

Diffusion models are a class of generative neural networks which can be trained to generate new data with features similar to features found in training data. In particular, diffusion models can be used to generate novel images. Diffusion models can be used for various image generation tasks including image super-resolution, generation of images with perceptual metrics, conditional generation (e.g., generation based on text guidance), image inpainting, and image manipulation.

Types of diffusion models include Denoising Diffusion Probabilistic Models (DDPMs) and Denoising Diffusion Implicit Models (DDIMs). In DDPMs, the generative process includes reversing a stochastic Markov diffusion process. DDIMs, on the other hand, use a deterministic process so that the same input results in the same output. Diffusion models may also be characterized by whether the noise is added to the image itself, or to image features generated by an encoder (i.e., latent diffusion).

Diffusion models work by iteratively adding noise to the data during a forward process and then learning to recover the data by denoising the data during a reverse process. For example, during training, guided latent diffusion model 500 may take an original image 505 in a pixel space 510 as input and apply and image encoder 515 to convert original image 505 into original image features 520 in a latent space 525. Then, a forward diffusion process 530 gradually adds noise to the original image features 520 to obtain noisy features 535 (also in latent space 525) at various noise levels.

Next, a reverse diffusion process 540 (e.g., a U-Net or a diffusion transformer ANN) gradually removes the noise from the noisy features 535 at the various noise levels to obtain denoised image features 545 in latent space 525. In some examples, the denoised image features 545 are compared to the original image features 520 at each of the various noise levels, and parameters of the reverse diffusion process 540 of the diffusion model are updated based on the comparison. Finally, an image decoder 550 decodes the denoised image features 545 to obtain an output image 555 in pixel space 510. In some cases, an output image 555 is created at each of the various noise levels. The output image 555 can be compared to the original image 505 to train the reverse diffusion process 540.

In some cases, image encoder 515 and image decoder 550 are pre-trained prior to training the reverse diffusion process 540. In some examples, they are trained jointly, or the image encoder 515 and image decoder 550 and fine-tuned jointly with the reverse diffusion process 540.

The reverse diffusion process 540 can also be guided based on a text prompt 560, or another guidance prompt, such as an image, a layout, a segmentation map, etc. The text prompt 560 can be encoded using a text encoder 565 (e.g., a multimodal encoder) to obtain guidance features 570 in guidance space 575. The guidance features 570 can be combined with the noisy features 535 at one or more layers of the reverse diffusion process 540 to ensure that the output image 555 includes content described by the text prompt 560. For example, guidance features 570 can be combined with the noisy features 535 using a cross-attention block within the reverse diffusion process 540. In embodiments of the image generation model described herein, the guidance features 570 may include the prompt features and the text features as generated by a word encoder and a glyph encoder, respectively. According to some aspects, the prompt features and the text features are each provided to separate cross-attention blocks within reverse diffusion process 540.

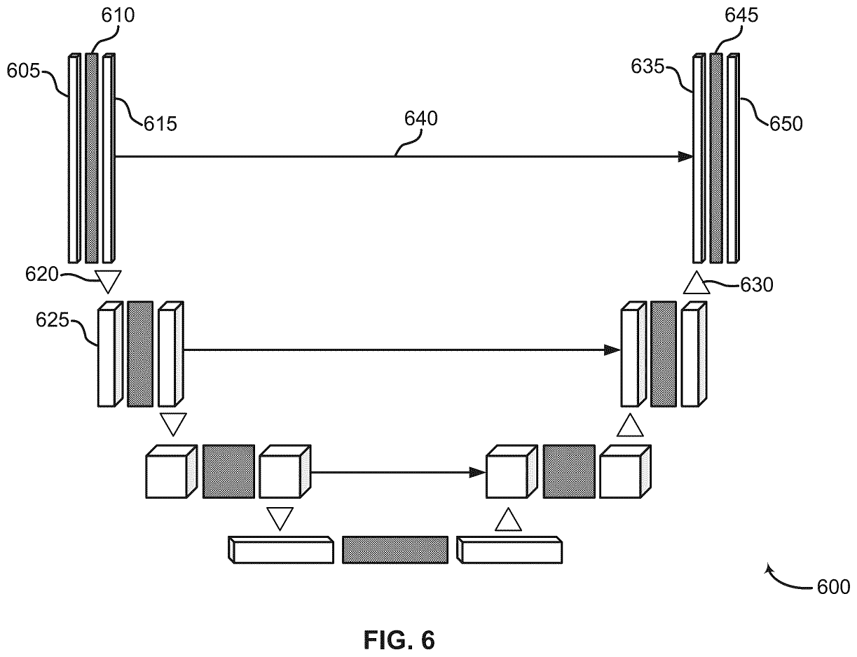

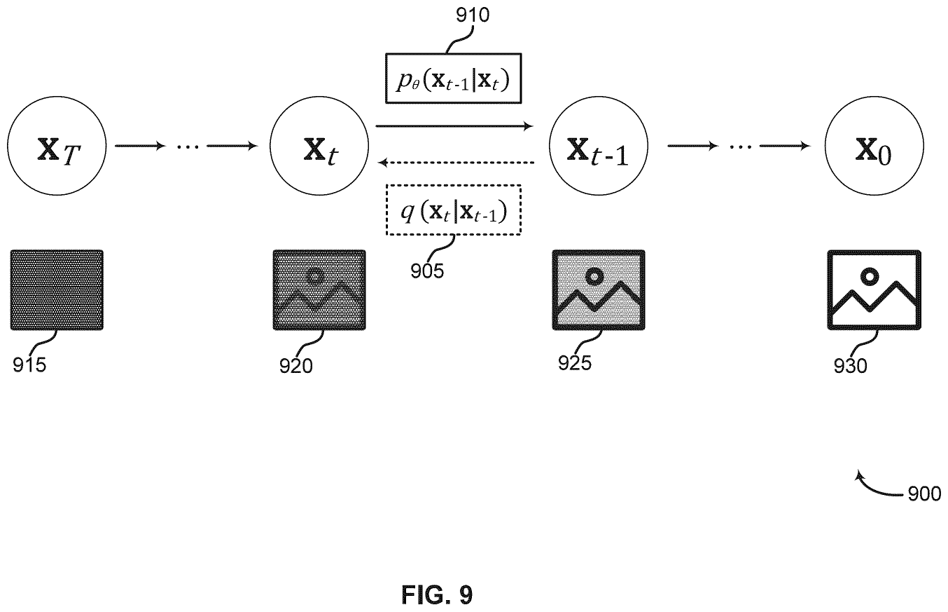

FIG. 6 shows an example of a U-Net 600 according to aspects of the present disclosure. In some examples, U-Net 600 is an example of the component that performs the reverse diffusion process 640 of guided diffusion model 500 described with reference to FIG. 5 and includes architectural elements of the image generation model 235 described with reference to FIG. 2. The U-Net 600 depicted in FIG. 6 is an example of, or includes aspects of, the architecture used within the reverse diffusion process described with reference to FIGS. 5 and 9.

In some examples, diffusion models are based on a neural network architecture known as a U-Net. The U-Net 600 takes input features 605 having an initial resolution and an initial number of channels and processes the input features 605 using an initial neural network layer 610 (e.g., a convolutional network layer) to produce intermediate features 615. The intermediate features 615 are then down-sampled using a down-sampling layer 620 such that down-sampled features 625 have a resolution less than the initial resolution and a number of channels greater than the initial number of channels.

This process is repeated multiple times, and then the process is reversed. That is, the down-sampled features 625 are up-sampled using up-sampling process 630 to obtain up-sampled features 635. The up-sampled features 635 can be combined with intermediate features 615 having a same resolution and number of channels via a skip connection 640. These inputs are processed using a final neural network layer 645 to produce output features 650. In some cases, the output features 650 have the same resolution as the initial resolution and the same number of channels as the initial number of channels.

In some cases, U-Net 600 takes additional input features to produce conditionally generated output. For example, the additional input features could include a vector representation of an input prompt. The additional input features can be combined with the intermediate features 615 within the neural network at one or more layers. For example, a cross-attention module can be used to combine the additional input features and the intermediate features 615. Embodiments of the U-Net 600 may incorporate multiple cross-attention modules dedicated to different condition signals, such as prompt features generated a word encoder and text features generated by a glyph encoder.

FIG. 7 shows an example of a pipeline for generating images with legible visual text according to aspects of the present disclosure. The example shown includes input prompt 700, word encoder 705, glyph encoder 710, OCR encoder 715, image generation model 720, and synthetic image 740.

Input prompt 700 is an example of, or includes aspects of, the corresponding element described with reference to FIGS. 1 and 3. Word encoder 705 is an example of, or includes aspects of, the corresponding element described with reference to FIGS. 2 and 3. Glyph encoder 710 is an example of, or includes aspects of, the corresponding element described with reference to FIGS. 2 and 3. OCR encoder 715 is an example of, or includes aspects of, the corresponding element described with reference to FIGS. 2, 4, and 11. Image generation model 720 is an example of, or includes aspects of, the corresponding element described with reference to FIGS. 2, 8, and 11.

In this example, the system first obtains input prompt 700, which includes a visual text. For example, the prompt may be “a postcard that says happy new year”, where “happy new year” is the visual text to be included in the generated image. Input prompt 700 is the input to word encoder 705 and glyph encoder 710 to generate prompt features fₚ and text features f_{T}, respectively. Additional detail regarding the feature generation is described with reference to FIGS. 3-4. In some embodiments, the visual text is extracted from input prompt 700 using one of various natural language processing (NLP) techniques, such as a language model (LM). In such embodiments, only the visual text from input prompt 700 is input to glyph encoder 710.

Some embodiments additionally extract OCR features from input prompt 700 (or alternatively, only the visual text within input prompt 700) using an OCR encoder 715. Additional detail regarding this process is described with reference to FIG. 4. The OCR features may be projected to the same embedding space as the prompt features, and appended to the prompt features fₚ with a separator token separating the original prompt features and OCR features to obtain a final fₚ. In at least one embodiment, the OCR features are additionally or alternatively appended to text features f_{T}.

In one aspect, image generation model 720 includes current sample 725, first cross-attention module 730, and second cross-attention module 735. First cross-attention module 730 and second cross-attention module 735 are examples of, or include aspects of, the corresponding elements described with reference to FIG. 2. Synthetic image 740 is an example of, or includes aspects of, the corresponding element described with reference to FIG. 8.

In this example, image generation model 720 processes two types of features: prompt features fₚ and text features f_{T}. First cross-attention module 730 processes the prompt features while second cross-attention module 735 processes the text features. In some embodiments, first cross-attention module 730 and second cross-attention module 735 share the same transformer architecture but maintain separate parameter weights through training. For example, prompt features fₚ and text features f_{T} may independently attend to latent image feature F before the attention results are combined, like so:

$$C {A}_{1} ( {f}_{P} , F ) + C {A}_{2} ( {f}_{T} , F ) \qquad ( 1 )$$

where CA₁ and CA₂ are the two cross attention modules with independent weights. The + denotes a combination operation of the attention outputs, which may include element-wise addition, weighted combination, concatenation followed by a linear projection, or other operations that combine the two attention maps into a single output feature map of compatible dimensionality with the image generation model's processing pipeline.

This separation allows the prompt features and the text features to influence the denoising of current sample 725 in distinct ways. For example, prompt features generally influence the larger structure of the generated image and its semantic content, whereas text features influence the placement and rendering of the visual text. According to some aspects, processing these features through separate cross-attention modules, rather than as a combined tensor in a single module, enables embodiments to disentangle their roles in the image generation process.

The image generation process may then proceed through iterative denoising to generate synthetic image 740. Additional detail regarding a reverse diffusion process is described with reference to FIGS. 5 and 9. Embodiments are not necessarily limited to U-Net based iterative diffusion, however, and some embodiments of image generation model 720 may be based on a single-pass distilled U-Net model, an iterative diffusion transformer (DiT) model, or other architectures that support conditional image generation through cross-attention. For example, some embodiments may incorporate aspects of transformer-based image generation models, autoregressive image generation models, or other architectures where cross-attention enables the incorporation of conditional information during the generation process.

FIG. 8 shows an example of a pipeline for upscaling generated images according to aspects of the present disclosure. The example shown includes noise map 800, image generation model 805, synthetic image 810, linear upscaling 815, noise addition 820, noised 2× synthetic image 825, additional image generation model 830, and upscaled synthetic image 835.

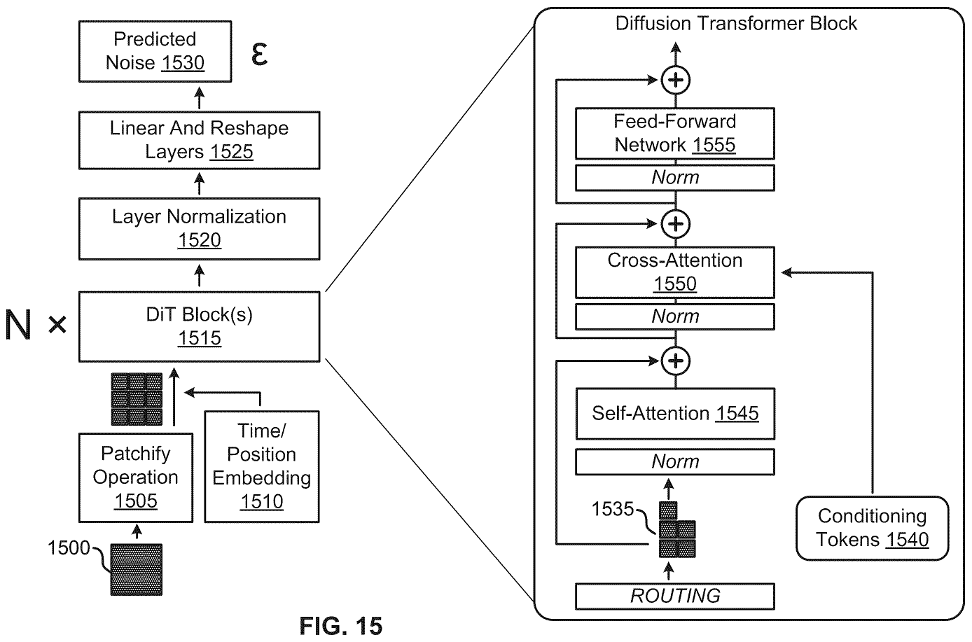

Image generation model 805 is an example of, or includes aspects of, the corresponding element described with reference to FIGS. 2, 7, and 11. Synthetic image 810 is an example of, or includes aspects of, the corresponding element described with reference to FIG. 7. Additional image generation model 830 is an example of, or includes aspects of, the corresponding element described with reference to FIG. 2. The image generation model 805 and the additional image generation model 830 may be, for example, a denoising diffusion model. Denoising diffusion architectures are described with reference to FIGS. 6 and 15.

In this example, noise map 800 is input to (or sampled within) image generation model 805, which then generates synthetic image 810 therefrom. The generation process may include external conditioning, as described with reference to FIGS. 4 and 7. Linear upscaling 815 then increases the resolution of synthetic image 810. According to some aspects, linear upscaling 815 operates on a pixel-representation of the image rather than a latent spatial map.

Noise addition 820 adds noise to the upscaled image to obtain noised 2× synthetic image 825. The amount of noise added may correspond to a particular timestep in a denoising process. For example, the amount of noise added may correspond to a timestep approximately 70% of the way through the denoising process t∈[0,T], such as t=0.7 T. Additional image generation model 830 then processes noised 2× synthetic image 825 to generate upscaled synthetic image 835. In some embodiments, additional image generation model 830 is specifically trained to operate on higher-resolution images and preserve fine details while maintaining the overall structure and text rendering quality established by image generation model 805.

FIG. 9 shows a diffusion process 900 according to aspects of the present disclosure. In some examples, diffusion process 900 describes an operation of the image generation model 235 described with reference to FIG. 2, such as the reverse diffusion process 540 of guided diffusion model 500 described with reference to FIG. 5.

As described above with reference to FIG. 5, using a diffusion model can involve both a forward diffusion process 905 for adding noise to an image (or features in a latent space) and a reverse diffusion process 910 for denoising the images (or features) to obtain a denoised image. The forward diffusion process 905 can be represented as q(xₜ|xₜ₋₁), and the reverse diffusion process 910 can be represented as p(xₜ₋₁|xₜ). In some cases, the forward diffusion process 905 is used during training to generate images with successively greater noise, and a neural network is trained to perform the reverse diffusion process 910 (i.e., to successively remove the noise).

In an example forward process for a latent diffusion model, the model maps an observed variable x₀ (either in a pixel space or a latent space) intermediate variables x₁, . . . , x_{T} using a Markov chain. The Markov chain gradually adds Gaussian noise to the data to obtain the approximate posterior q(x_{1:T}|x₀) as the latent variables are passed through a neural network such as a U-Net or a DiT, where x₁, . . . , x_{T} have the same dimensionality as x₀.

The neural network may be trained to perform the reverse process. During the reverse diffusion process 910, the model begins with noisy data x_{T}, such as a noisy image 915 and denoises the data to obtain the p(xₜ₋₁|xₜ). At each step t−1, the reverse diffusion process 910 takes xₜ, such as first intermediate image 920, and t as input. Here, t represents a step in the sequence of transitions associated with different noise levels, The reverse diffusion process 910 outputs xₜ₋₁, such as second intermediate image 925 iteratively until x_{T} reverts back to x₀, the original image 930. The reverse process can be represented as:

$${p}_{θ} ( {x}_{t - 1} \vert {x}_{t} ) : = N ( {x}_{t - 1} ; {μ}_{θ} ( {x}_{t} , t ) , {\sum }_{θ} ( {x}_{t} , t ) ) \qquad ( 2 )$$

The joint probability of a sequence of samples in the Markov chain can be written as a product of conditionals and the marginal probability:

$${x}_{T} : {p}_{θ} ( {x}_{0 : T} ) : = p ( {x}_{T} ) {\prod }_{t = 1}^{T} {p}_{θ} ( {x}_{t - 1} \vert {x}_{t} ) \qquad ( 3 )$$

where p(x_{T})=N(x_{T}; 0, I) is the pure noise distribution as the reverse process takes the outcome of the forward process, a sample of pure noise, as input and

$${\prod }_{t = 1}^{T} {p}_{θ} ( {x}_{t - 1} \vert {x}_{t} )$$

represents a sequence of Gaussian transitions corresponding to a sequence of addition of Gaussian noise to the sample.

At inference time, observed data x₀ in a pixel space can be mapped into a latent space as input and a generated data \tilde{x} is mapped back into the pixel space from the latent space as output. In some examples, x₀ represents an original input image with low image quality, latent variables x₁, . . . , x_{T} represent noisy images, and i represents the generated image with high image quality.

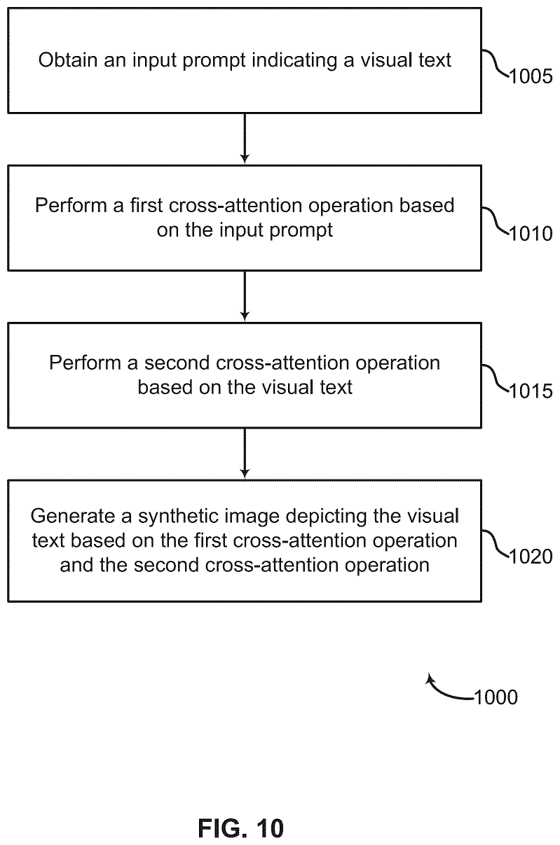

FIG. 10 shows an example of a method 1000 for generating a synthetic image according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 1005, the system obtains an input prompt indicating a visual text. The input prompt may include both semantic content and text to be rendered visually in the generated image. As used herein, a “visual text” refers to a text intended to be rendered in a generated image. In some embodiments, the visual text is extracted from the semantic text. The system processes this input prompt through multiple encoders to extract different types of features. In some cases, the operations of this step refer to, or may be performed by, an image processing apparatus as described with reference to FIGS. 1 and 2.

At operation 1010, the system performs a first cross-attention operation based on the input prompt. For example, the system may process prompt features extracted by a word encoder through a first cross-attention module. The word level encoder may generate a sequence of token embeddings from the input prompt, where each token corresponds to a word or sub-word from the input prompt and is represented as a vector in a high-dimensional vector space. These prompt features contribute semantic information to the image generation process. In some cases, the operations of this step refer to, or may be performed by, a first cross-attention module of an image generation model as described with reference to FIGS. 2 and 7.

At operation 1015, the system performs a second cross-attention operation based on the visual text. The system processes text features extracted by a glyph encoder through a second cross-attention module. The glyph encoder processes the input prompt to generate a sequence of vector representations, sometimes referred to as “character embeddings,” for each character in the input. These embeddings capture fine-grained features specific to individual characters and their context within the input prompt. These text features contribute character-level information to improve text reproduction. The text features may be generated from the entire input prompt, or may be generated from the visual text portion of the input prompt. In some cases, the operations of this step refer to, or may be performed by, a second cross-attention module of the image generation model as described with reference to FIGS. 2 and 7.

At operation 1020, the system generates, using the image generation model, a synthetic image depicting the visual text based on the first cross-attention operation and the second cross-attention operation. The system combines the results of both cross-attention operations to influence the image generation process. For example, the system may generate the synthetic image based on a denoising process as described with reference to FIGS. 5 and 9.

### Training Methods

FIG. 11 shows an example of a pipeline for computing an OCR loss 1155 according to aspects of the present disclosure. The example shown includes database 1100, ground-truth image 1105, ground-truth text prompt 1110, image encoder 1115, ground-truth latent features 1120, latent segmentation model 1125, binary mask 1130, image generation model 1135, predicted features 1140, OCR encoder 1145, training component 1150, and OCR loss 1155.

Database 1100 is an example of, or includes aspects of, the corresponding element described with reference to FIG. 1. Image generation model 1135 is an example of, or includes aspects of, the corresponding element described with reference to FIGS. 2, 7, and 8. OCR encoder 1145 is an example of, or includes aspects of, the corresponding element described with reference to FIGS. 2, 4, and 7, thought embodiments are not necessarily limited thereto, and the OCR encoder 1145 may be a separate model configured to generate OCR embeddings for training purposes. Training component 1150 is an example of, or includes aspects of, the corresponding element described with reference to FIG. 2.

In this example, database 1100 provides training data that includes ground-truth image 1105 and its corresponding ground-truth text prompt 1110. Image encoder 1115 processes ground-truth image 1105 to generate ground-truth latent features 1120. According to some aspects, these latent features occupy the same feature space used by image generation model 1135 during generation.

Latent segmentation model 1125 analyzes ground-truth latent features 1120 to generate binary mask 1130. Binary mask 1130 identifies regions in the latent feature space that correspond to text placement in ground-truth image 1105. This mask enables the training process to focus the OCR loss computation on text-relevant regions.

Image generation model 1135 receives the ground-truth text prompt 1110, processed through word and glyph encoders as described with reference to FIGS. 2 and 3. Based on this conditioning, image generation model 1135 generates predicted latent features 1140. Both the ground-truth latent features 1120 and predicted latent features 1140 are then processed by OCR encoder 1145 to obtain embeddings used in the calculation of an OCR loss. For example, training component 1150 computes OCR loss 1155 based on the difference between OCR features from the ground-truth and predicted latent features, like so:

$${L}_{O C R} = {\vert OCR ( {F}_{g round truth} ) - OCR ( ( {F}_{predict} ) ) \vert}_{2} \qquad ( 4 )$$

where OCR denotes the OCR encoder 1145, F_{ground truth} and F_{predict} denote the ground-truth latent features 1120 and predicted latent features 1140, respectively, and |⋅|₂ denotes the L2 norm. The binary mask is applied to L_{OCR} to weight it spatially in regions of the text placement:

$${L}_{t o t a l} = {L}_{Diffusion} + {M}_{O C R} \cdot {L}_{O C R} \qquad ( 5 )$$

where ⋅ denotes element-wise multiplication of the mask with the OCR loss, and L_{Diffusion} refers to other training objectives, such as the conventional diffusion model training loss.

In some embodiments, OCR encoder 1145 may alternatively operate directly in the pixel space rather than the latent space. In such embodiments, the latent features are first decoded to pixel representations before OCR feature extraction:

$${L}_{O C R} = {\vert OCR ( {I}_{g round truth} ) - OCR ( D ( {F}_{predict} ) ) \vert}_{2} \qquad ( 6 )$$

where I_{ground truth} the ground-truth image in the pixel space, and D denotes a latent feature decoder.

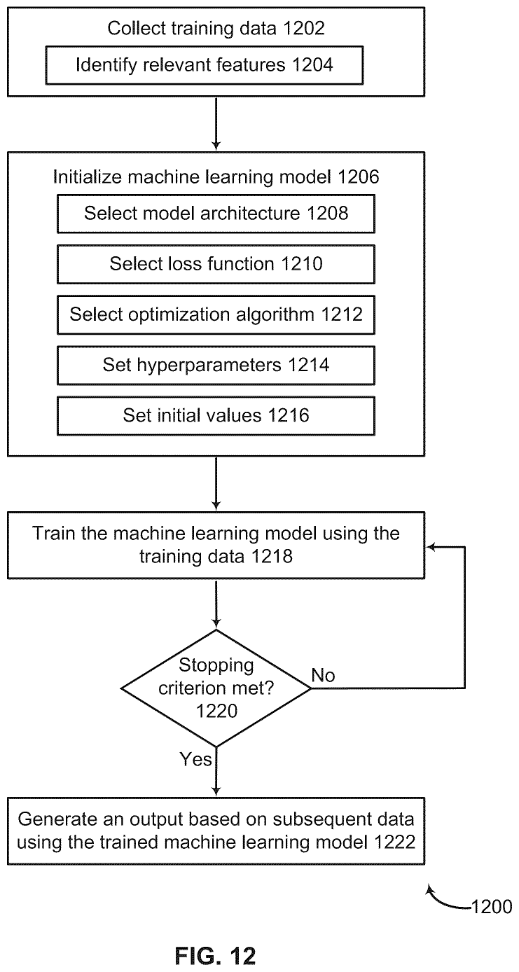

FIG. 12 is a flow diagram depicting an algorithm as a step-by-step procedure 1200 in an example implementation of operations performable for training a machine-learning model. In some embodiments, the procedure 1200 describes an operation of the training component 255 described for configuring the image generation model 235 and the additional image generation model 250 as described with reference to FIG. 2. The procedure 1200 provides one or more examples of generating training data, use of the training data to train a machine-learning model, and use of the trained machine-learning model to perform a task.

To begin in this example, a machine-learning system collects training data (block 1202) that is to be used as a basis to train a machine-learning model, i.e., which defines what is being modeled. The training data is collectable by the machine-learning system from a variety of sources. Examples of training data sources include public datasets, service provider system platforms that expose application programming interfaces (e.g., social media platforms), user data collection systems (e.g., digital surveys and online crowdsourcing systems), and so forth. Training data collection may also include data augmentation and edited data generation techniques to expand and diversify available training data, balancing techniques to balance a number of positive and negative examples, and so forth.

The machine-learning system is also configurable to identify features that are relevant (block 1204) to a type of task, for which the machine-learning model is to be trained. Task examples include classification, natural language processing, generative artificial intelligence, recommendation engines, reinforcement learning, clustering, and so forth. To do so, the machine-learning system collects the training data based on the identified features and/or filters the training data based on the identified features after collection. The training data is then utilized to train a machine-learning model.

In order to train the machine-learning model in the illustrated example, the machine-learning model is first initialized (block 1206). Initialization of the machine-learning model includes selecting a model architecture (block 1208) to be trained. Examples of model architectures include neural networks, convolutional neural networks (CNNs), long short-term memory (LSTM) neural networks, generative adversarial networks (GANs), decision trees, support vector machines, linear regression, logistic regression, Bayesian networks, random forest learning, dimensionality reduction algorithms, boosting algorithms, deep learning neural networks, etc.

A loss function is also selected (block 1210). The loss function is utilized to measure a difference between an output of the machine-learning model (i.e., predictions) and target values (e.g., as expressed by the training data) to be used to train the machine-learning model. This loss function may include, for example, the OCR loss as described with reference to FIG. 11. Additionally, an optimization algorithm is selected (1212) that is to be used in conjunction with the loss function to optimize parameters of the machine-learning model during training, examples of which include gradient descent, stochastic gradient descent (SGD), and so forth.

Initialization of the machine-learning model further includes setting initial values of the machine-learning model (block 1214) examples of which includes initializing weights and biases of nodes to improve efficiency in training and computational resources consumption as part of training. Hyperparameters are also set that are used to control training of the machine learning model, examples of which include regularization parameters, model parameters (e.g., a number of layers in a neural network), learning rate, batch sizes selected from the training data, and so on. The hyperparameters are set using a variety of techniques, including use of a randomization technique, through use of heuristics learned from other training scenarios, and so forth.

The machine-learning model is then trained using the training data (block 1218) by the machine-learning system. A machine-learning model refers to a computer representation that can be tuned (e.g., trained and retrained) based on inputs of the training data to approximate unknown functions. In particular, the term machine-learning model can include a model that utilizes algorithms (e.g., using the model architectures described above) to learn from, and make predictions on, known data by analyzing training data to learn and relearn to generate outputs that reflect patterns and attributes expressed by the training data.

Examples of training types include supervised learning that employs labeled data, unsupervised learning that involves finding an underlying structures or patterns within the training data, reinforcement learning based on optimization functions (e.g., rewards and/or penalties), use of nodes as part of “deep learning,” and so forth. The machine-learning model, for instance, is configurable as including a plurality of nodes that collectively form a plurality of layers. The layers, for instance, are configurable to include an input layer, an output layer, and one or more hidden layers. Calculations are performed by the nodes within the layers through the hidden states through a system of weighted connections that are “learned” during training, e.g., through use of the selected loss function and backpropagation to optimize performance of the machine-learning model to perform an associated task.

As part of training the machine-learning model, a determination is made as to whether a stopping criterion is met (decision block 1220), i.e., which is used to validate the machine-learning model. The stopping criterion is usable to reduce overfitting of the machine-learning model, reduce computational resource consumption, and promote an ability of the machine-learning model to address previously unseen data, i.e., that is not included specifically as an example in the training data. Examples of a stopping criterion include but are not limited to a predefined number of epochs, validation loss stabilization, achievement of a performance improvement threshold, whether a threshold level of accuracy has been met, or based on performance metrics such as precision and recall. If the stopping criterion has not been met (“no” from decision block 1220), the procedure 1200 continues training of the machine-learning model using the training data (block 1218) in this example.

If the stopping criterion is met (“yes” from decision block 1220), the trained machine-learning model is then utilized to generate an output based on subsequent data (block 1222). The trained machine-learning model, for instance, is trained to perform a task as described above and therefore, once trained, is configured to perform that task based on subsequent data received as an input and processed by the machine-learning model.

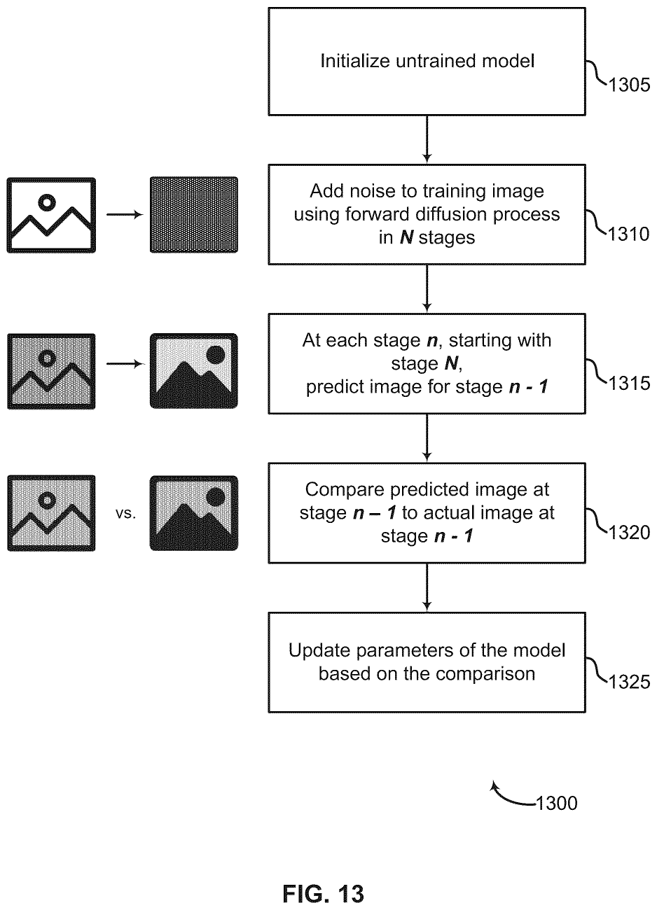

FIG. 13 shows an example of a method 1300 for training a diffusion model according to aspects of the present disclosure. In some embodiments, the method 1300 describes an operation of the training component 255 described for configuring the image generation model 235 and the additional image generation model 250 as described with reference to FIG. 2. The method 1300 represents an example for training a reverse diffusion process as described above with reference to FIG. 9. In some examples, these operations are performed by a system including a processor executing a set of codes to control functional elements of an apparatus, such as the guided diffusion model described in FIG. 3.

Additionally or alternatively, certain processes of method 1300 may be performed using special-purpose hardware. Generally, these operations are performed according to the methods and processes described in accordance with aspects of the present disclosure. In some cases, the operations described herein are composed of various substeps or are performed in conjunction with other operations.

At operation 1305, the user initializes an untrained model. Initialization can include defining the architecture of the model and establishing initial values for the model parameters. In some cases, the initialization can include defining hyper-parameters such as the number of layers, the resolution and channels of each layer blocks, the location of skip connections, and the like.

At operation 1310, the system adds noise to a training image using a forward diffusion process in N stages. In some cases, the forward diffusion process is a fixed process where Gaussian noise is successively added to an image. In latent diffusion models, the Gaussian noise may be successively added to features in a latent space.

At operation 1315, the system at each stage n, starting with stage N, a reverse diffusion process is used to predict the image or image features at stage n−1. For example, the reverse diffusion process can predict the noise that was added by the forward diffusion process, and the predicted noise can be removed from the image to obtain the predicted image. In some cases, an original image is predicted at each stage of the training process.

At operation 1320, the system compares predicted image (or image features) at stage n−1 to an actual image (or image features), such as the image at stage n−1 or the original input image. For example, given observed data x, the diffusion model may be trained to minimize the variational upper bound of the negative log-likelihood −log p_{θ}(x) of the training data.

At operation 1325, the system updates parameters of the model based on the comparison. For example, parameters of a U-Net or a DiT may be updated using gradient descent. Time-dependent parameters of the Gaussian transitions can also be learned.

FIG. 14 shows an example of a computing device 1400 according to aspects of the present disclosure. The example shown includes computing device 1400, processor(s) 1405, memory subsystem 1410, communication interface 1415, I/O interface 1420, user interface component(s), and channel 1430.

In some embodiments, computing device 1400 is an example of, or includes aspects of, an image generation apparatus as described in FIGS. 1 and 2. In some embodiments, computing device 1400 includes one or more processors 1405 are configured to execute instructions stored in memory subsystem 1410 to obtain an input prompt indicating a visual text; perform, using an image generation model, a first cross-attention operation based on the input prompt; perform, using the image generation model, a second cross-attention operation based on the visual text; and generate, using the image generation model, a synthetic image depicting the visual text based on the first cross-attention operation and the second cross-attention operation.

According to some aspects, computing device 1400 includes one or more processors 1405. In some cases, a processor is an intelligent hardware device, (e.g., a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or a combination thereof. In some cases, a processor is configured to operate a memory array using a memory controller. In other cases, a memory controller is integrated into a processor. In some cases, a processor is configured to execute computer-readable instructions stored in a memory to perform various functions. In some embodiments, a processor includes special purpose components for modem processing, baseband processing, digital signal processing, or transmission processing.

According to some aspects, memory subsystem 1410 includes one or more memory devices. Examples of a memory device include random access memory (RAM), read-only memory (ROM), or a hard disk. Examples of memory devices include solid state memory and a hard disk drive. In some examples, memory is used to store computer-readable, computer-executable software including instructions that, when executed, cause a processor to perform various functions described herein. The memory may store various parameters of machine learning models used in the components described with reference to FIG. 2. In some cases, the memory contains, among other things, a basic input/output system (BIOS) which controls basic hardware or software operation such as the interaction with peripheral components or devices. In some cases, a memory controller operates memory cells. For example, the memory controller can include a row decoder, column decoder, or both. In some cases, memory cells within a memory store information in the form of a logical state.

According to some aspects, communication interface 1415 operates at a boundary between communicating entities (such as computing device 1400, one or more user devices, a cloud, and one or more databases) and channel 1430 and can record and process communications. In some cases, communication interface 1415 is provided to enable a processing system coupled to a transceiver (e.g., a transmitter and/or a receiver). In some examples, the transceiver is configured to transmit (or send) and receive signals for a communications device via an antenna.

According to some aspects, I/O interface 1420 is controlled by an I/O controller to manage input and output signals for computing device 1400. In some cases, I/O interface 1420 manages peripherals not integrated into computing device 1400. In some cases, I/O interface 1420 represents a physical connection or port to an external peripheral. In some cases, the I/O controller uses an operating system such as iOS®, ANDROID®, MS-DOS®, MS-WINDOWS®, OS/2®, UNIX®, LINUX®, or other known operating systems. In some cases, the I/O controller represents or interacts with a modem, a keyboard, a mouse, a touchscreen, or a similar device. In some cases, the I/O controller is implemented as a component of a processor. In some cases, a user interacts with a device via I/O interface 1420 or via hardware components controlled by the I/O controller.

According to some aspects, user interface component(s) 1425 enable a user to interact with computing device 1400. In some cases, user interface component(s) 1425 include an audio device, such as an external speaker system, an external display device such as a display screen, an input device (e.g., a remote-control device interfaced with a user interface directly or through the I/O controller), or a combination thereof. In some cases, user interface component(s) 1425 include a GUI.

FIG. 15 shows an example of a diffusion transformer (DiT) architecture according to aspects of the present disclosure. The DiT architecture is an alternative to the U-Net backbone described with reference to FIG. 6. The example shown includes noised latent 1500, patchify operation 1505, timestep embedding 1510, DiT block(s), layer normalization 1520, linear and reshape layers 1525, predicted noise 1530, input tokens 1535, conditioning tokens 1540, self-attention 1545, cross-attention 1550, and feed-forward network 1555.

The DiT architecture processes noised latent 1500, which may be a noised version of an input image encoded in a latent space. Patchify operation 1505 divides the noised latent into a sequence of patches that are processed as tokens. The tokens are vector representations of each patch of the image in latent space, and are adjusted through attention processes. Each of the tokens also receives timestep embedding 1510, which encodes the current denoising timestep, and a positional embedding which encodes each token's spatial position in the image. The tokens and timestep information are processed through N DiT block(s) 1515, where N may be 28 in some embodiments, though other values of N are possible.

Each DiT block 1515 includes multiple processing stages. In some embodiments, a token selection process is performed where a router model determines which tokens to send for additional processing via attention mechanisms, and which tokens to skip to the next DiT block or diffusion timestep. The remaining tokens are processed as input tokens 1535, which interact with conditioning tokens 1540 through multiple attention mechanisms. Self-attention 1545 allows input tokens to attend to each other, while cross-attention 1550 enables input tokens to attend to the conditioning tokens 1540. The outputs are then processed through feed-forward network 1555. This process repeats for each DiT block in the sequence.

After processing through all DiT blocks, the outputs undergo layer normalization 1520 followed by linear and reshape layers 1525. The final output is predicted noise 1530, which represents the model's prediction of the noise that was added to create the initial noised latent 1500. The predicted noise 1530 is removed noised latent 1500 at each diffusion timestep. At the end of the denoising schedule, the latent sample is decoded to generate the synthetic image in pixel space.

FIG. 16 shows an example of a visual text according to aspects of the present disclosure. The example shown includes input prompt 1600, image generation model 1605, output image 1610, and visual text 1615.

A user may provide input prompt 1600 that describes an image to be generated. In this example, the input prompt 1600 is “a postcard with a rooster that says happy new year.” In some cases, the input prompt 1600 includes a visual text 1615, which is text that should be rendered legibly in the generated image. The system may automatically recognize the visual text 1615 as text intended to be rendered. For example, the system may extract visual text 1615 from input prompt 1600 using one of various natural language processing (NLP) techniques, such as a language model (LM).

According to some aspects, the system then processes the input prompt 1600 and visual text 1615 in separate pipelines to extract prompt features and text features, respectively. Additional detail regarding this process is provided with reference to FIG. 7. The system uses the prompt features and the text features as conditioning to image generation model 1605, which then generates output image 1610. The output image 1610 includes a legible reproduction of the visual text 1615.

Accordingly, the present disclosure includes the following aspects.

A method for image generation is described. One or more aspects of the method include obtaining an input prompt indicating a visual text; performing, using an image generation model, a first cross-attention operation based on the input prompt; performing, using the image generation model, a second cross-attention operation based on the visual text; and generating, using the image generation model, a synthetic image depicting the visual text based on the first cross-attention operation and the second cross-attention operation.

Some examples of the method, apparatus, non-transitory computer readable medium, and system further include generating prompt features representing the input prompt. Some examples further include generating intermediate image features for the synthetic image based on the prompt features, wherein the first cross-attention operation is based on the prompt features and the intermediate image features. Some examples further include performing optical character recognition (OCR) on the visual text, wherein the prompt features are based on the OCR.

Some examples of the method, apparatus, non-transitory computer readable medium, and system further include generating text features representing the visual text. Some examples further include generating intermediate image features for the synthetic image based on the text features, wherein the second cross-attention operation is based on the text features and the intermediate image features. Some examples further include combining a result of the first cross-attention operation and a result of the second cross-attention operation to obtain combined image features, wherein the synthetic image is generated based on the combined image features. Some examples further include upscaling, using an additional image generation model, the synthetic image to obtain a high resolution image. In some aspects, the image generation model is trained using an OCR loss.

A method for image generation is described. One or more aspects of the method include obtaining an input prompt indicating a visual text; encoding, using a word encoder of an image generation model, the input prompt to obtain prompt features; encoding, using a glyph encoder of the image generation model, the input prompt to obtain text features; and generating, using the image generation model, a synthetic image depicting the visual text based on the prompt features and the text features.

Some examples of the method, apparatus, non-transitory computer readable medium, and system further include performing optical character recognition (OCR) on the visual text, wherein the prompt features are based on the OCR. Some examples further include generating intermediate image features for the synthetic image based on the prompt features. Some examples further include performing a cross-attention operation is based on the prompt features and the intermediate image features to obtain the synthetic image.

Some examples of the method, apparatus, non-transitory computer readable medium, and system further include generating intermediate image features for the synthetic image based on the text features. Some examples further include performing a cross-attention operation is based on the text features and the intermediate image features to obtain the synthetic image. Some examples further include upscaling, using an additional image generation model, the synthetic image to obtain a high resolution image. In some aspects, the image generation model is trained using an OCR loss.

An apparatus for image generation is described. One or more aspects of the apparatus include a memory component; a processing device coupled to the memory component, the processing device configured to perform operations comprising: obtaining an input prompt indicating a visual text; performing, using an image generation model, a first cross-attention operation based on the input prompt; performing, using the image generation model, a second cross-attention operation based on the visual text; and generating, using the image generation model, a synthetic image depicting the visual text based on the first cross-attention operation and the second cross-attention operation.

Some examples of the apparatus, system, and method further include a word encoder configured to encode the input prompt to obtain prompt features. Some examples further include a glyph encoder configured to encode the input prompt to obtain text features. Some examples further include an OCR encoder configured to encode the input prompt to obtain OCR embeddings.

Some examples of the apparatus, system, and method further include an additional image generation model configured to upscale the synthetic image to obtain a high resolution synthetic image. In some aspects, the image generation model, the additional image generation model, or both are trained using an OCR loss. In some aspects, the image generation model, the additional image generation model, or both comprise a guided latent diffusion model.

The description and drawings described herein represent example configurations and do not represent all the implementations within the scope of the claims. For example, the operations and steps may be rearranged, combined or otherwise modified. Also, structures and devices may be represented in the form of block diagrams to represent the relationship between components and avoid obscuring the described concepts. Similar components or features may have the same name but may have different reference numbers corresponding to different figures.

Some modifications to the disclosure may be readily apparent to those skilled in the art, and the principles defined herein may be applied to other variations without departing from the scope of the disclosure. Thus, the disclosure is not limited to the examples and designs described herein, but is to be accorded the broadest scope consistent with the principles and novel features disclosed herein.

The described methods may be implemented or performed by devices that include a general-purpose processor, a digital signal processor (DSP), an application specific integrated circuit (ASIC), a field programmable gate array (FPGA) or other programmable logic device, discrete gate or transistor logic, discrete hardware components, or any combination thereof. A general-purpose processor may be a microprocessor, a conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Thus, the functions described herein may be implemented in hardware or software and may be executed by a processor, firmware, or any combination thereof. If implemented in software executed by a processor, the functions may be stored in the form of instructions or code on a computer-readable medium.

Computer-readable media includes both non-transitory computer storage media and communication media including any medium that facilitates transfer of code or data. A non-transitory storage medium may be any available medium that can be accessed by a computer. For example, non-transitory computer-readable media can comprise random access memory (RAM), read-only memory (ROM), electrically erasable programmable read-only memory (EEPROM), compact disk (CD) or other optical disk storage, magnetic disk storage, or any other non-transitory medium for carrying or storing data or code.

Also, connecting components may be properly termed computer-readable media.

For example, if code or data is transmitted from a website, server, or other remote source using a coaxial cable, fiber optic cable, twisted pair, digital subscriber line (DSL), or wireless technology such as infrared, radio, or microwave signals, then the coaxial cable, fiber optic cable, twisted pair, DSL, or wireless technology are included in the definition of medium. Combinations of media are also included within the scope of computer-readable media.

In this disclosure and the following claims, the word “or” indicates an inclusive list such that, for example, the list of X, Y, or Z means X or Y or Z or XY or XZ or YZ or XYZ. Also the phrase “based on” is not used to represent a closed set of conditions. For example, a step that is described as “based on condition A” may be based on both condition A and condition B. In other words, the phrase “based on” shall be construed to mean “based at least in part on.” Also, the words “a” or “an” indicate “at least one.”

What is claimed is:

1. A method comprising:
obtaining an input prompt indicating a visual text;
performing, using an image generation model, a first cross-attention operation based on the input prompt;
performing, using the image generation model, a second cross-attention operation based on the visual text; and
generating, using the image generation model, a synthetic image depicting the visual text based on the first cross-attention operation and the second cross-attention operation.

2. The method of claim 1, further comprising:
generating, using a word encoder, prompt features representing the input prompt; and
generating intermediate image features for the synthetic image based on the prompt features, wherein the first cross-attention operation is based on the prompt features and the intermediate image features.

3. The method of claim 2, further comprising:
performing optical character recognition (OCR) on the visual text, wherein the prompt features are based on the OCR.

4. The method of claim 1, further comprising:
generating, using a glyph encoder, text features representing the visual text; and
generating intermediate image features for the synthetic image based on the text features, wherein the second cross-attention operation is based on the text features and the intermediate image features.

5. The method of claim 1, wherein generating the synthetic image comprises:
combining a result of the first cross-attention operation and a result of the second cross-attention operation to obtain combined image features, wherein the synthetic image is generated based on the combined image features.

6. The method of claim 1, further comprising:
upscaling, using an additional image generation model, the synthetic image to obtain a high resolution image.

7. The method of claim 1, wherein:
the image generation model is trained using an OCR loss.

8. A non-transitory computer readable medium storing code for image processing, the code comprising instructions that, when executed by at least one processor, cause the at least one processor to perform operations comprising:
obtaining an input prompt indicating a visual text;
encoding, using a word encoder of an image generation model, the input prompt to obtain prompt features;
encoding, using a glyph encoder of the image generation model, the input prompt to obtain text features; and
generating, using the image generation model, a synthetic image depicting the visual text based on the prompt features and the text features.

9. The non-transitory computer readable medium of claim 8, the code further comprising instructions that, when executed by the at least one processor, cause the at least one processor to perform operations comprising:
performing optical character recognition (OCR) on the visual text, wherein the prompt features are based on the OCR.

10. The non-transitory computer readable medium of claim 8, the code further comprising instructions that, when executed by the at least one processor, cause the at least one processor to perform operations comprising:
generating intermediate image features for the synthetic image based on the prompt features; and
performing a cross-attention operation is based on the prompt features and the intermediate image features to obtain the synthetic image.

11. The non-transitory computer readable medium of claim 8, the code further comprising instructions that, when executed by the at least one processor, cause the at least one processor to perform operations comprising:
generating intermediate image features for the synthetic image based on the text features; and
performing a cross-attention operation is based on the text features and the intermediate image features to obtain the synthetic image.

12. The non-transitory computer readable medium of claim 8, the code further comprising instructions that, when executed by the at least one processor, cause the at least one processor to perform operations comprising:
upscaling, using an additional image generation model, the synthetic image to obtain a high resolution image.

13. The non-transitory computer readable medium of claim 8, wherein:
the image generation model is trained using an OCR loss.

14. A system comprising:
a memory component;
a processing device coupled to the memory component, the processing device configured to perform operations comprising:
obtaining an input prompt indicating a visual text;
performing, using an image generation model, a first cross-attention operation based on the input prompt;
performing, using the image generation model, a second cross-attention operation based on the visual text; and
generating, using the image generation model, a synthetic image depicting the visual text based on the first cross-attention operation and the second cross-attention operation.

15. The system of claim 14, the system further comprising:
a word encoder configured to encode the input prompt to obtain prompt features.

16. The system of claim 14, the system further comprising:
a glyph encoder configured to encode the input prompt to obtain text features.

17. The system of claim 14, the system further comprising:
an OCR encoder configured to encode the input prompt to obtain OCR embeddings.

18. The system of claim 14, the system further comprising:
an additional image generation model configured to upscale the synthetic image to obtain a high resolution synthetic image.

19. The system of claim 14, wherein:
the image generation model is trained using an OCR loss.

20. The system of claim 14, wherein:
the image generation model comprises a guided latent diffusion model.
